(19) United States
(12) Patent Application Publication
(10) Pub. No.: US 2003/0038821 A1
(43) Pub. Date: Feb. 27, 2003

(54) Computer controlled interactive touch display pad with transparent full character keyboard overlaying displayed text and graphics

(76) Inventor: Joshua Dickinson Kraft, Austin, TX (US)

Correspondence Address: J.B. KRAFT, SUITE 5-C, 71C COLORADO ST., AUSTIN, TX, 78701, US

(21) Appl. No.: 09/939,445

(22) Filed: Aug. 27, 2001

(51) Int. Cl. G09G 5/00

(52) U.S. Cl. 345/629

(57) ABSTRACT

A portable computer controlled user interactive touch responsive read/write display pad comprising the combination of a display screen displaying text and graphics, a transparent touch sensitive pad covering said display screen, an implementation responsive to cursive drawing or characters touch input for displaying such drawing or characters on said display screen together with an implementation for displaying a full character keyboard on said display screen and responsive to touch inputs to characters on said keyboard for displaying said touch keyboard inputs as text entries within said displayed text and graphics. This full character keyboard is preferably superimposed upon and transparent to said displayed text and graphics in the displayed document. There is further included an implementation for selectively rendering either one of said implementation responsive to cursive drawing or said implementation responsive to inputs to touch keyboard non-interactive while the other of said means remains interactive to thereby permit the unimpeded functioning of the means remaining interactive. In accordance with an aspect of the invention, there is an implementation for varying the transparentness of said superimposed keyboard whereby said keyboard is less transparent when said keyboard is interactive and more transparent when said keyboard is non-interactive.

### TECHNICAL FIELD

The present invention relates to user interactive computer supported display technology and particularly to such user interactive systems and methods related to touch screen technology.

### BACKGROUND OF RELATED ART

In recent years, convergence of the data processing industry with the consumer electronics and communications industries has accelerated extensive consumer and business involvement in computer driven technologies. As a result of these changes, all aspects of work in business and technology requires human/computer interfaces. There is a need to make computer directed activities accessible to a substantial portion of people who up to a few years ago, were computer illiterate, or at best, computer indifferent. In order for the extensive computer supported market places to continue and be commercially productive, it will be necessary for a large segment of computer indifferent workers and consumers to be involved in computer interfaces. Thus, the challenge of technology is to create interfaces to computers that are as close to the real world as possible.

In this connection, the mouse, which has been the primary input device to computers for a generation, is still considered to be a physically awkward input device. Consequently, there has been considerable effort in the development of the touch screen or touch panel. It is easy to use because it allows the user to point directly to the display screen with his finger or a pen or stylus to make selections that result in graphic or alphanumeric changes on the display screen. The touch panel, in various forms, has been in use for several years. Several different technologies have been involved in touch panels. Original touch panels used a series of infrared LEDs and light sensors, such as photodiodes, to provide low resolution panels of up to 50 resolvable positions. The LEDs and sensors form a grid of invisible light beams that the finger breaks to, thus, indicate its position. The capacitively coupled touch panels were able to develop a resolution of about 100 resolvable positions. Higher resolution touch screens have been developed using a variety of technologies from sound waves reflected off fingers to conductive/resistive layers separated by insulative material broken down by touch.

Recent developments, which have dramatically improved the clarity and resolution of liquid crystal displays, as well as the improved resolution and responsiveness in touch panels overlaid on such liquid crystal displays, have renewed the hopes among students, academics, researchers and literary developers for an effective paperless notebook. Such a notebook should be one which is light and portable; can store up to several books, sequences of pages of which may be read via the display screen; enables the entry of cursive drawings, graphics and script, e.g. class or scientific notes and annotations respective to the text and images; as well as the entry of typed text.

The latter has presented a problem because for greatest convenience it requires a full keyboard. This has led to awkward notebook structures with a separate swing-out touch keyboard not unlike laptop PCs. Also, some touchpads have a separate keyboard apart from the displayed text and graphics document for typed text entries. Other simpler display notebooks have some minimal pecking in of alphanumeric characters but not from a full keyboard array.

### SUMMARY OF THE PRESENT INVENTION

The present invention provides a solution to the above-mentioned shortcomings of touch screen display notebooks by eliminating the hinged swing-out keyboard while having a full keyboard available for the entry of typed text, as well as a simultaneous display of the text/graphics document being read or modified. To achieve such results, the present invention provides a portable computer controlled user interactive touch responsive read/write display pad comprising the combination of a display screen displaying text and graphics, a transparent touch sensitive pad covering said display screen, means responsive to cursive drawing or characters touch input for displaying such drawing or characters on said display screen, means for displaying a full character keyboard on said display screen and means responsive to touch inputs to characters on said keyboard for displaying said touch keyboard inputs as text entries within said displayed text and graphics.

This full character keyboard is preferably superimposed upon and transparent to said displayed text and graphics in the displayed document. There is further included means for selectively rendering either one of said means responsive to cursive drawing or said means responsive to inputs to touch keyboard non-interactive while the other of said means remains interactive to thereby permit the unimpeded functioning of the means remaining interactive. In accordance with an aspect of the invention, there are means for varying the transparentness of said superimposed keyboard whereby said keyboard is less transparent when said keyboard is interactive and more transparent when said keyboard is non-interactive.

There is also provided means responsive to an input to a key in said keyboard for rendering interactive said means responsive to keyboard inputs and for rendering non-interactive said means responsive to cursive drawing.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit, an LCD display and overlaid touch panel display that is capable of implementing the present invention;

FIG. 2 is a diagrammatic general three-dimensional view of the touch sensitive notebook of the present invention;

FIG. 3 is a diagrammatic view of the notebook display screen of the present invention having a page of a book or document with text and graphics;

FIG. 4 is the diagrammatic view of the displayed page of FIG. 3 during editing or cursive data entry via a stylus; in this mode the superimposed keyboard has a high transparentness;

FIG. 5 is the diagrammatic view of the displayed page of FIG. 3 during editing or text data entry via the keyboard; in this mode the superimposed keyboard has a relatively low transparentness;

FIG. 6 is a flowchart of the basic elements of the program in a computer controlled display system of this invention for coordinating the input to the touch display with the transparentness of the keyboard; and

FIG. 7 is a flowchart of the steps involved in an illustrative run of data entry or document editing within the process set up in FIG. 6.

### DETAILED DESCRIPTION OF THE PREFERRED EMBODIMENT

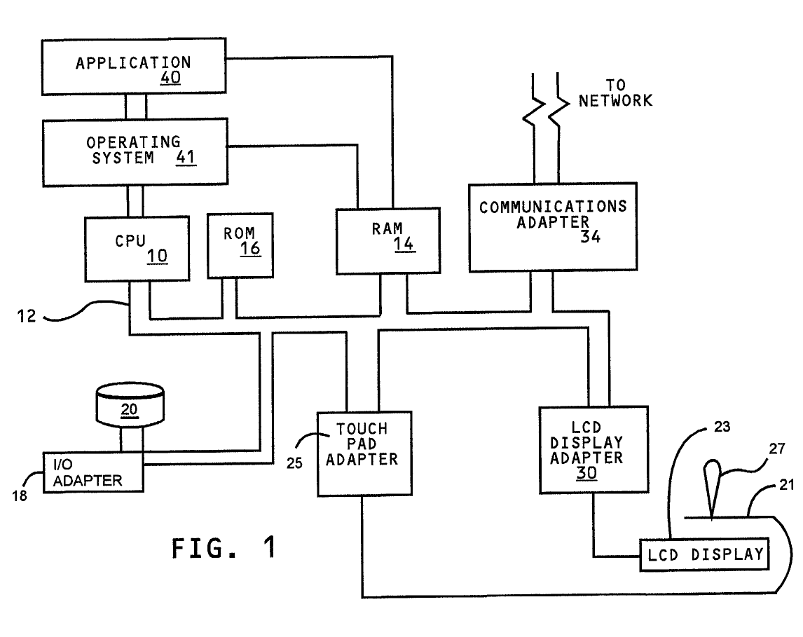

Referring to FIG. 1, a data processing system is shown which may function as the computer controlled display terminal with the touch pad data entry display coupled to the primary display in accordance with the present invention. The computer controlled primary LCD display may be a LCD display personal computer unit made up of a central processing unit (CPU) 10, such as one of the PC processors available from International Business Machines Corporation (IBM), Dell Corp. or Compaq Corp., which is provided and interconnected to various other components by system bus 12. An operating system 41 runs on CPU 10 and provides control and is used to coordinate the functions of the various components of FIG. 1, including the touch screen 21 LCD display 23 pad which will hereinafter be described in greater detail. Operating system 41 may be one of the commercially available operating systems such as Microsoft Windows95™ or WindowsNT™, as well as UNIX or IBM's AIX operating systems. A program for simultaneously displaying the images of the primary display document or book on the touch pad 21 display 23 and for applying the superimposed transparent keyboard image to the LCD display, application 40, to be subsequently described, runs in conjunction with operating system 41 and provides output calls to the operating system 41 which implement the various functions to be performed by the application 40. A read only memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory when the system is in operation. Otherwise, when the system is dormant, most of the software, including operating system 40 and applications 41, are stored in disk storage device 20. I/O adapter 18 may be a Small Computer System Interface (SCSI) adapter that communicates with the disk storage device 20, i.e. a hard drive. Communications adapter 34 interconnects bus 12 with an outside network enabling the data processing system to communicate with other such systems over a Local Area Network (LAN) or Wide Area Network (WAN), which includes, of course, the Internet. Thus, the system of the present invention may be used with screens and pages received over the Internet. I/O devices, such as keyboard 24 and mouse 32, are also connected to system bus 12 via user interface adapter 22. It is through such input devices that the user may make conventional data entries.

With respect to the display pad input devices used in the invention, any conventional touch screen display may be used. Typically, in FIG. 1, there is an LCD display having surface 23 upon which the visual output from the computer is generated via pad display adapter 30. A touch sensitive display panel 21 is superimposed upon display surface 23. This touch screen, which is about ¼″ to ½″ from surface 23, is responsive to a touch stimulus, i.e. stylus 27, applied by the user to make the graphic, cursive and other entries to be subsequently described. The touch screen 21 resolution is determined by digitizing circuitry (not shown) in a touch screen adapter 25 to form a two-dimensional array of discrete coordinate points. A touch stimulus applied by stylus 27 or by the user's fingers in the superimposed keyboard to any of the coordinate points is detected by a sensor array (not shown) in the touch panel 21. The sensor array generates an analog signal responsive to the force imparted to the touch screen. The stimulus may also be imparted proximate to the touch screen. The signal is digitized by a sampling A to D convertor circuit (not shown) in touch panel 21 to produce an input data value. This data value, together with the coordinates to which it relates, are transmitted from touch panel 21 to touch pad display adapter 25. The input data value corresponding to each set of coordinates is conventionally refreshed by the A to D converter circuit about 60 times a second. The touch pad adapter 25 connected to the bus architecture 12 passes each set of coordinates to the bus architecture 12 to the CPU 10 and operating system 41 wherein this input is applied to the LCD display 23 via LCD display adapter 30.

The touch panels or screens 21 may use any of the standard technologies discussed above. In the present embodiment, higher resolution panels using resistive/conductive composites should provide best results. Such structures use two slightly separated layers of transparent material, one coated with a thin layer of conductive material and the other with resistive material. The pressure of the stylus forces the layers to touch and the voltage drop across the resistive substrate is measured and used to determine the coordinates of the touched positions. There are many such conductive/resistive touch screen displays on the market that may be used in the implementation of the present invention, such as the IBM 2489 Model 600 and PGI Super Nightingale.

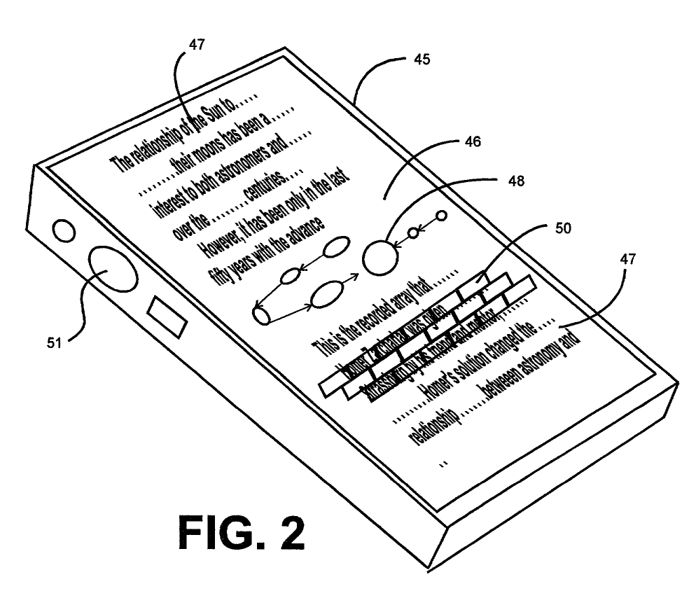

A three-dimensional view of the housing for the notebook display of the present invention is shown in FIG. 2. The notebook housing 45 includes touch sensitive display screen 46 showing a page of a book or document with printed text 47 and graphics 48. There is a superimposed displayed keyboard 50 and some controls 51 for the notebook.

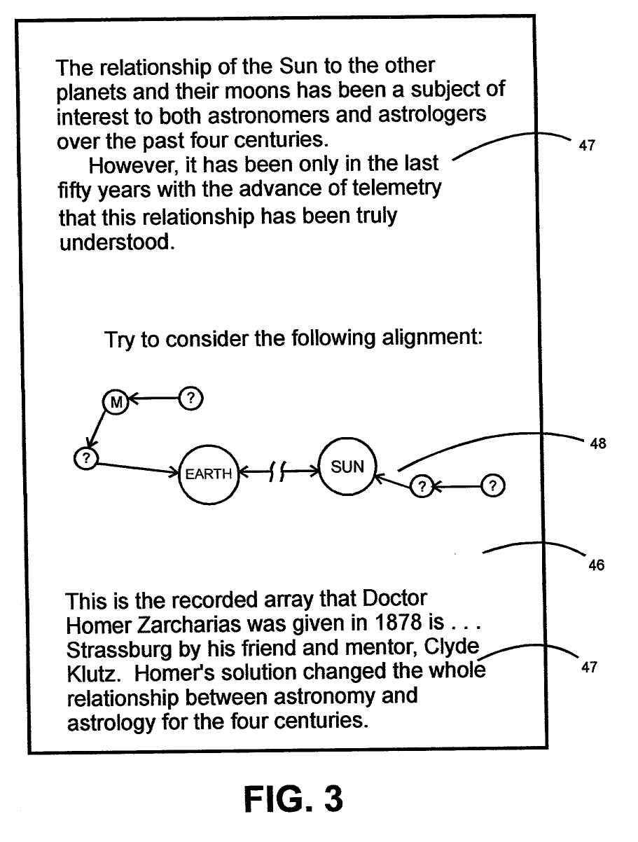

There will now be described a simple illustration of the present invention with respect to the display screens of FIGS. 3 through 5. When the screen images are described, it will be understood that these may be rendered by storing image and text creation programs, such as those in any conventional window operating system in the RAM 14 of the system of FIG. 1. The operating system is diagrammatically shown in FIG. 1 as operating system 41. The display screens of FIGS. 3 through 5 are presented to the viewer on LCD display 23 of FIG. 1.

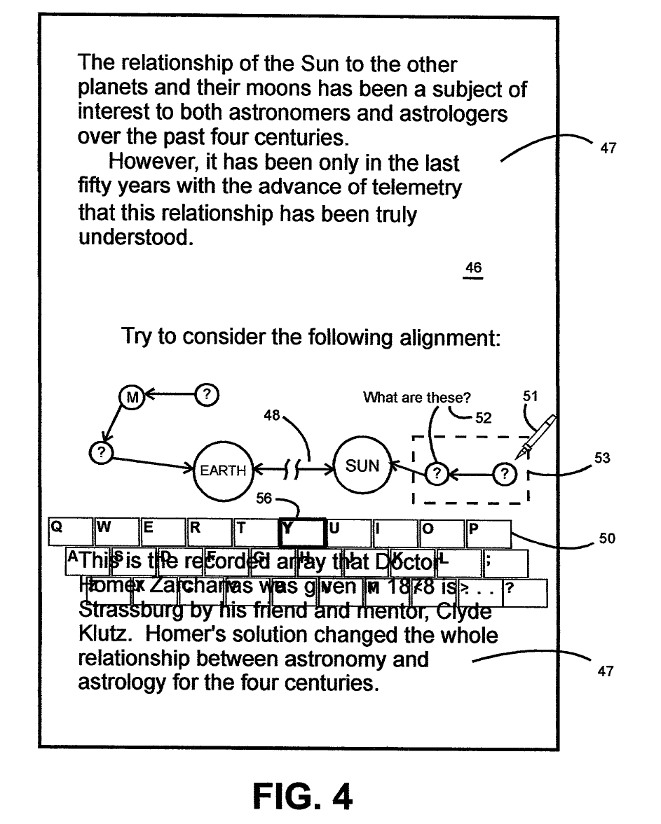

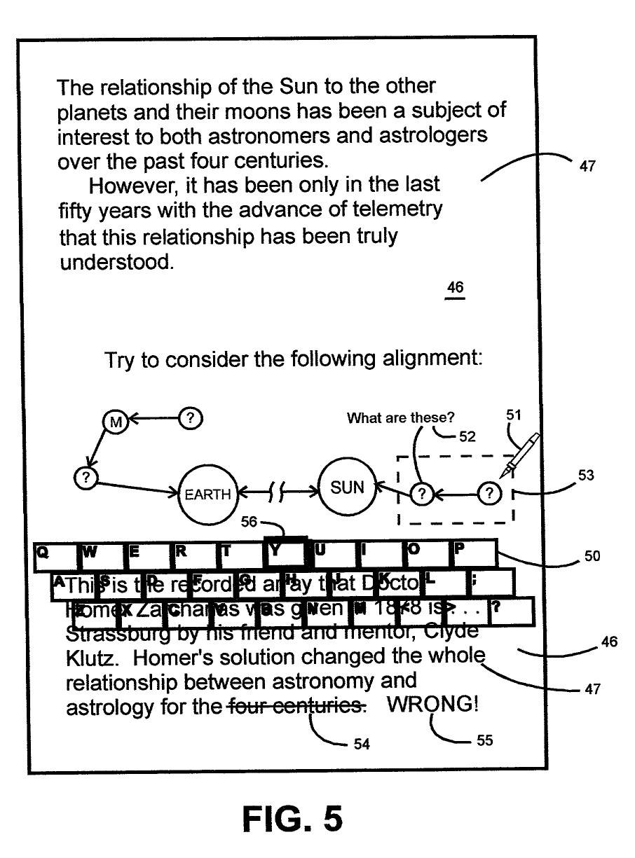

FIG. 3 shows an illustrative display screen during a document or book reading session. The display may be scrolled or paged conventionally. The screen 46 contains text 47 and graphics 48. If the user decides to edit, annotate or take class notes in his notebook, he may switch into an edit mode as shown in FIG. 4 where he may use pressure stylus 51 in the conventional manner to add cursive notes 52 or cursive drawing or graphics 53. During this edit session, a full keyboard 50 will appear. The keyboard is transparent so that the user may still be able to see the underlying text and graphics. Since the editing in FIG. 4 is being done in the cursive mode, the keyboard 50 has a high transparentness, i.e. it is a “ghost” image to indicate its position and presence. The operating system graphics may be set up so that the keyboard entry edit mode for the entry of typed text is switched to when the user hits any key in the keyboard. Alternatively, one of the keys in the keyboard may be set up to be the switch key. In the present example, “y” key 56 performs this role, i.e. the user must hit this key to switch to the keyboard entry mode shown is FIG. 5. In this keyboard entry mode, the keyboard 50 becomes less transparent and more clearly defined for ease of use. The keyboard is then used for entry of text 55 or for keystroke editing 55. While stylus 51 does not function during the keyboard entry mode of FIG. 5, it is included in the figure just for illustrative comparison purposes. In carrying out the functions of FIGS. 4 and 5, the touch responsive display pad may be set up to respond conventionally to the stylus pressure. In the keyboard mode of FIG. 5, pressure response programs may be set up so that pressure applied at the positions of each of the respective keys is translated to an image of the character on the screen at the point of editing.

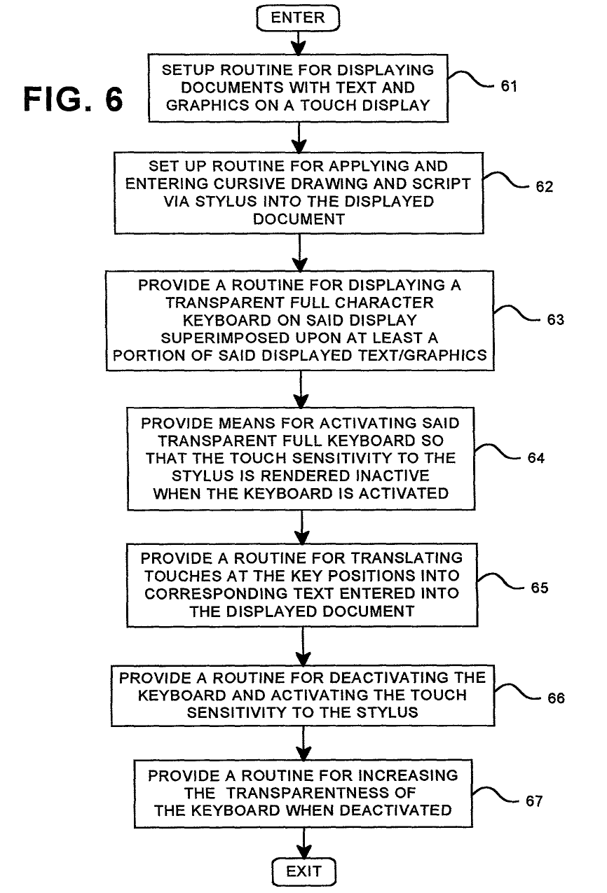

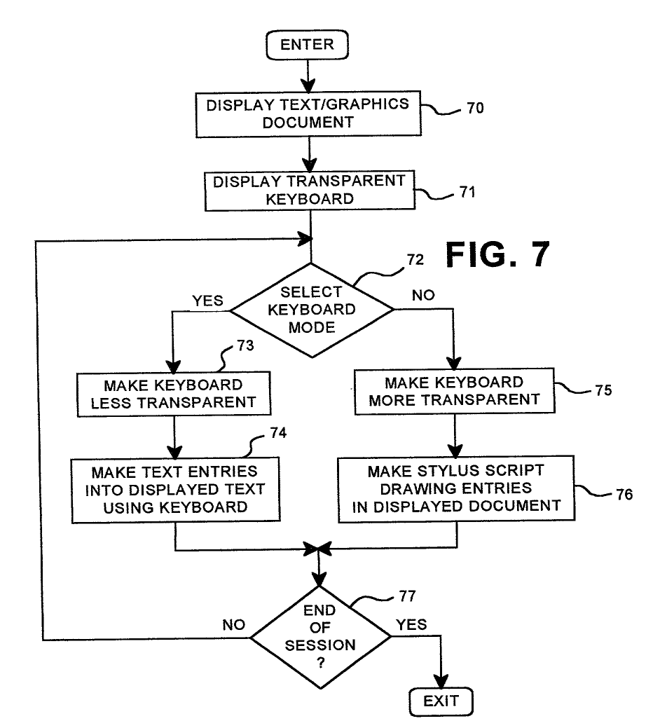

Now, with reference to FIGS. 6 and 7, we will describe a process implemented by the present invention in conjunction with the flowcharts of these figures. FIG. 6 is a flowchart showing the development of a process according to the present invention for a touch sensitive notebook with text entry via a superimposed keyboard. A routine is set up for displaying documents or books with graphics and text on a touch display, step 61. A routine is set up for entering cursive drawing and script via a stylus into the displayed document, step 62. A routine is provided for displaying a full character keyboard on the touch display superimposed upon at least a portion of the displayed text and graphics, step 63. Means are provided for activating the transparent full keyboard so that the touch sensitivity to the stylus is rendered inactive when the keyboard is activated, step 64. A routine is provided for translating touches at the key positions into corresponding text entered into the displayed book or document, step 65. A routine is provided for deactivating the keyboard and activating the touch sensitivity to the stylus for cursive entries, step 66. A routine is also provided for increasing the transparentness of the keyboard when the keyboard is deactivated, step 67.

The illustrative running of the process will now be described with respect to FIG. 7. First, step 70, the text/graphics document or book page is displayed. The user selects the edit mode and the transparent keyboard is displayed superimposed over the text/graphics, step 71. A determination is then made as to whether the user has selected the keyboard text-entry mode of editing, step 72. If Yes, the keyboard is made less transparent, i.e. more clearly displayed, step 73, and desired text entries are made in the document via the touch keyboard, step 74. If the determination in step 72 is No, the keyboard mode has not been selected, then step 45, the keyboard is made more transparent, i.e. a “ghost” outline, step 75, and stylus script and drawing entries are made into the document, step 76. Upon the completion of either a text, step 74, or a stylus entry, step 76, function, a determination may conveniently be made as to whether the session is at an end, step 77. If Yes, the session is exited. If No, the session is returned to step 72 where a further determination is made as to whether the user has selected the keyboard text-entry mode of editing and the process is repeated with respect to the current or new page.

Although certain preferred embodiments have been shown and described, it will be understood that many changes and modifications may be made therein without departing from the scope and intent of the appended claims.

1. A portable computer controlled user interactive touch responsive read/write display pad comprising:
a display screen displaying text and graphics;
a transparent touch sensitive pad covering said display screen;
means responsive to cursive drawing or characters touch input for displaying such drawing or characters on said display screen;
means for displaying a full character keyboard on said display screen; and
means responsive to touch inputs to characters on said keyboard for displaying said touch keyboard inputs as text entries within said displayed text and graphics.

2. The display pad of claim 1 wherein said full character keyboard is superimposed upon and transparent to said displayed text and graphics.

3. The display pad of claim 2 further including means for selectively rendering either one of said means responsive to cursive drawing or said means responsive to inputs to touch keyboard non-interactive, while the other of said means remains interactive to thereby permit the unimpeded functioning of the means remaining interactive.

4. The display pad of claim 2 further including means for varying the transparentness of said superimposed keyboard.

5. The display pad of claim 3 further including means for varying the transparentness of said superimposed keyboard whereby said keyboard is less transparent when said keyboard is interactive and more transparent when said keyboard is non-interactive.

6. The display pad of claim 3 further including means responsive to an input to a key in said keyboard for rendering interactive said means responsive to keyboard inputs and for rendering non-interactive said means responsive to cursive drawing.

7. The display pad of claim 6 further including means for varying the transparentness of said superimposed keyboard whereby said keyboard is less transparent when said keyboard is interactive and more transparent when said keyboard is non-interactive.

8. In a portable computer controlled user interactive touch responsive read/write display pad having a display screen displaying text and graphics, and a transparent touch sensitive pad covering said display screen, a method for making both cursive and typed modifications to said displayed text and graphics comprising:
displaying cursive drawing or cursive characters on said display screen responsive to cursive drawing or characters touch input;
displaying a full character keyboard on said display screen; and
responsive to touch inputs to characters on said keyboard, displaying such touch inputs as text entries within said displayed text and graphics.

9. The method of claim 8 wherein said full character keyboard is superimposed upon and transparent to said displayed text and graphics.

10. The method of claim 9 further including the step of selectively rendering either one of said step responsive to cursive drawing or said step responsive to inputs to touch keyboard non-interactive while the other of said steps remains interactive to thereby permit the unimpeded functioning of the step remaining interactive.

11. The method of claim 9 further including the step of varying the transparentness of said superimposed keyboard.

12. The method of claim 10 further including the step of varying the transparentness of said superimposed keyboard whereby said keyboard is less transparent when said keyboard is interactive and more transparent when said keyboard is non-interactive.

13. The method of claim 10 further including the step responsive to an input to a key in said keyboard of rendering interactive said step responsive to keyboard inputs and for rendering non-interactive said step responsive to cursive drawing.

14. The method of claim 13 further including the step of varying the transparentness of said superimposed keyboard whereby said keyboard is less transparent when said keyboard is interactive and more transparent when said keyboard is non-interactive.
